(19) United States
(12) Patent Application Publication
(10) Pub. No.: US 2007/0256661 A1
(43) Pub. Date: Nov. 8, 2007

(54) Piston With Vaporizing Ring

(76) Inventor: Andrew F. Smith, Laredo, TX (US)

Correspondence Address: Michael D. Paul;Gunn & Lee, P.C., Suite 1500, 700 N. St. Mary's Street, San Antonio, TX, 78205, US

(21) Appl. No.: 11/745,273

(22) Filed: May 7, 2007

Related U.S. Application Data
(60) Provisional application No. 60/746,528, filed on May 5, 2006.

(51) Int. Cl. F02F 1/00; F02G 5/00; F01B 29/04

(52) U.S. Cl. 123/254; 123/543; 60/712

(57) ABSTRACT

A novel piston design for use in a cylinder of an internal combustion engine. The piston comprises a piston body adapted for reciprocating movement within the cylinder, and a connected vaporizing ring having top and a bottom surfaces. The piston body and vaporizing ring, together with the inner sidewall of the cylinder, define a vapor chamber. The vaporizing ring has a plurality of generally cylindrically-shaped passages providing fuel/air communication paths from the top surface through the vaporizing ring into the vapor chamber. These passages are evenly-distributed throughout said vaporizing ring.

### CROSS-REFERENCES TO RELATED APPLICATIONS

This original non-provisional application claims priority to U.S. provisional application No. 60/746,528, filed May 5, 2006, which is incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates generally to combustion engines and, more specifically, a novel piston design for use in combustion engines. The present invention also includes the piston in combination with a six-stroke engine to better vaporize a fuel/air mixture prior to igniting the mixture, thus resulting in a better, more complete burn. In addition, the present invention contemplates the use of electronically or hydraulically actuated intake and exhaust valves for selectively providing access to and from cylinders of such an engine.

2. Description of the Related Art

Combustion engines are, by their nature, inefficient. Not only is energy from the explosion during a combustion stroke lost through friction of moving parts within the engine, but chemical energy is wasted from incomplete burning of the fuel/air mixture injected into the cylinder of an internal combustion engine.

Numerous inventions have been directed toward increasing the efficiency of the combustion during the combustion stroke of an engine. One technique is to include a regenerative member as part of a piston that will capture and retain heat from the explosions that have occurred during previous combustion cycles. For example, U.S. Pat. No. 4,280,468 includes a porous regenerative member that captures the heat during an exhaust stroke. This recaptured heat is stored by the regenerative member, and preheats the fuel/air mixture during the next intake cycle. Similarly, U.S. Pat. No. 4,790,284 disclosed a moveable heat exchanger located between the piston and the cylinder head that captures thermal energy from the exhaust stroke for use in later cycles.

Other prior art addresses the efficiency problem by focusing on more thorough vaporization, or “misting,” of the fuel/air mixture. In conventional internal combustion engines, the fuel is mixed with air and then sprayed into a combustion chamber formed between the piston and the cylinder head. The mixture is then ignited by a spark plug, with the resulting explosion forcing the piston away from the cylinder head in order to turn an attached shaft. Typically, not all of the fuel droplets are burned in combustion, meaning that some fuel remains unused or wasted during a given combustion cycle.

Generally, the better the mixing, or degree of vaporization, of the fuel and air, the more fuel is burned and greater efficiency provided. For example, U.S. Pat. No. 5,937,838 addresses increasing the degree of vaporization through the use of a screening device located within the fuel line before the intake port of each cylinder. As fuel flows from, for example, a carburetor toward the engine block, the fuel and air pass through the screen to facilitate mixing, resulting in a finer mist upon entry into the cylinder and a lesser volume of uncombusted fuel after the combustion stroke.

Because generally the degree of vaporization correlates to turbulent flow of the air/gas mixture, the present invention addresses wasted fuel and other problems unsolved by the prior art by providing a novel piston design for increasing the degree of vaporization of the fuel/air mixture, thus decreasing the amount of unburned fuel remaining after the combustion stroke of an engine.

### BRIEF SUMMARY OF THE INVENTION

The present invention includes a novel piston for use in a cylinder of an internal combustion engine. The piston comprises a piston body adapted for reciprocating movement within the cylinder, and a connected vaporizing ring having top and a bottom surfaces. The piston body and vaporizing ring, together with the inner sidewall of the cylinder, define a vapor chamber. The vaporizing ring has a plurality of generally cylindrically-shaped passages providing fuel/air communication paths from the top surface through the vaporizing ring into the vapor chamber. These passages are evenly-distributed throughout the vaporizing ring. As the fuel/air mixture moves through the passages into the vapor chamber, the turbulent flow increases the degree of vaporization of the mixture, resulting in a more-readily combustible mixture.

Another aspect of the present invention includes a combustion engine incorporating the novel piston design disclosed herein. The engine includes at least one cylinder having a bore in selective communication with an intake port and an exhaust port, at least one piston as described and adapted for reciprocating movement within the bore, an electrically- or hydraulically-triggerable actuator connected to each of the intake and exhaust valves for selective opening and closing thereof, and actuating means operably connected to each of the actuators for selective actuation thereof. The engine of the present invention may use a six-stroke cycle including an intake stroke, a first compression stroke, a vapor stroke, a second compression stroke, a combustion stroke, and an exhaust stroke.

### BRIEF DESCRIPTION OF THE SEVERAL VIEWS OF THE DRAWING

The present invention, as well as further objects and features thereof, are more clearly and fully set forth in the following description of the preferred and alternative embodiments, which should be read with reference to the accompanying drawings, wherein:

FIG. 1 is a sectional view of the preferred embodiment of the piston of the present invention following an intake stroke of a combustion engine;

FIG. 2 is an elevational view of the vaporizing ring of the preferred embodiment;

FIG. 3 is a partial sectional view of the piston of the preferred embodiment following a compression stroke;

FIG. 4 is a partial sectional view of an alternative embodiment of the present invention following an intake stroke;

FIG. 5 is an elevational view of the vaporizing ring of the alternative embodiment;

FIG. 6 is a partial sectional view of the alternative embodiment following a compression stroke;

FIG. 7 is a state diagram of a six-stroke engine incorporating the piston design of the present invention; and

FIG. 8 is a functional block diagram of a system incorporating the novel piston design.

### DETAILED DESCRIPTION OF THE PREFERRED AND OTHER EMBODIMENTS

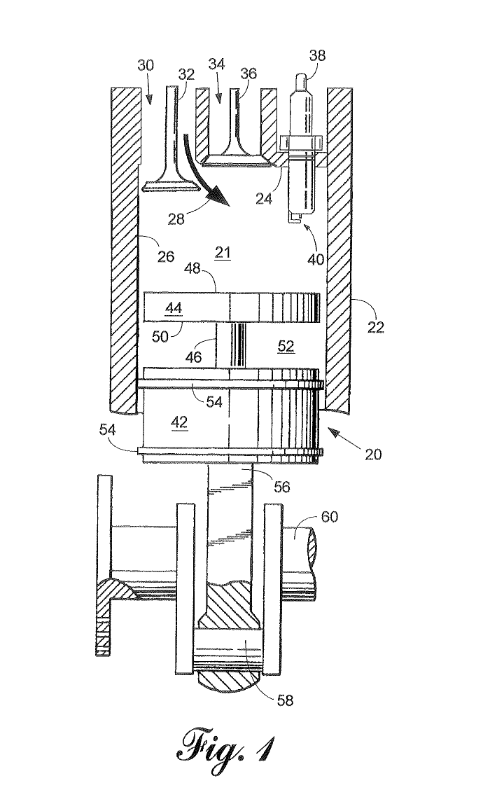

FIG. 1 discloses the piston 20 of the present invention between an intake stroke and a compression stroke of a cycle an internal combustion engine. The piston 20 is adapted for reciprocating movement within the bore 21 of a cylinder 22, which cylinder 22 defines a cylinder head 24 and sidewall 26. A fuel/air mixture 28 is provided through an intake port 30, access to which is controlled by selectively opening and closing an intake valve 32. After combustion of the fuel/air mixture 28, the resulting exhaust is forced from the cylinder 22 through an exhaust port 34, access to which is controlled by selectively opening and closing an exhaust valve 36. A spark plug 38 threaded through the cylinder head 24 provides an ignition source for the fuel/air mixture 28 using a spark gap 40.

The preferred embodiment of the piston 20 includes a piston body 42 connected to a vaporizing ring 44 by a stem 46. The vaporizing ring 44 and stem 46 are made from the same high-temperature material (e.g., ceramic) as the piston body 42. The vaporizing ring 44 has a top surface 48 and a bottom surface 50. The bottom surface 50 of the vaporizing ring 44 and piston body 42 define a vapor chamber 52, which is further defined by the sidewall 26 of the cylinder 22. The piston body 42 includes sealing members 54 that seal the bore 21 against the entry or egress of gasses. The piston body 42 is attached to a shaft 60 with a connecting rod 56. The connecting rod 56 is attached to a cam 58 that rotates about the longitudinal axis of the shaft 60 as the piston 20 reciprocates between the “top” and “down” positions in the cylinder 22.

As shown in FIG. 1, the intake valve 32 is open during the intake stroke of the engine. During the intake stroke, the fuel/air mixture 28 is drawn into the bore 21 through the intake port 30 while the intake valve 32 is in the “open” position. The fuel/air mixture 28 received during the intake stroke expands to fill the bore 21.

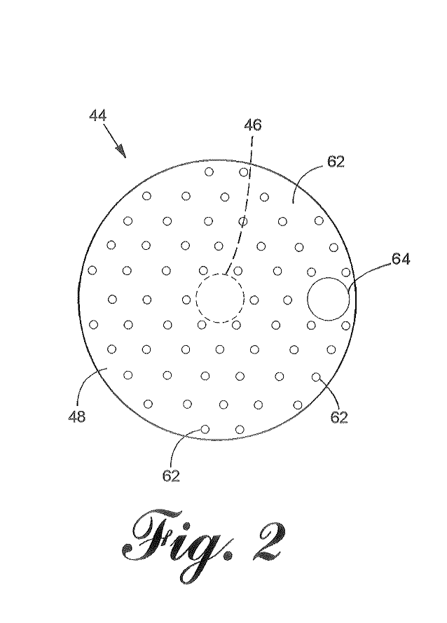

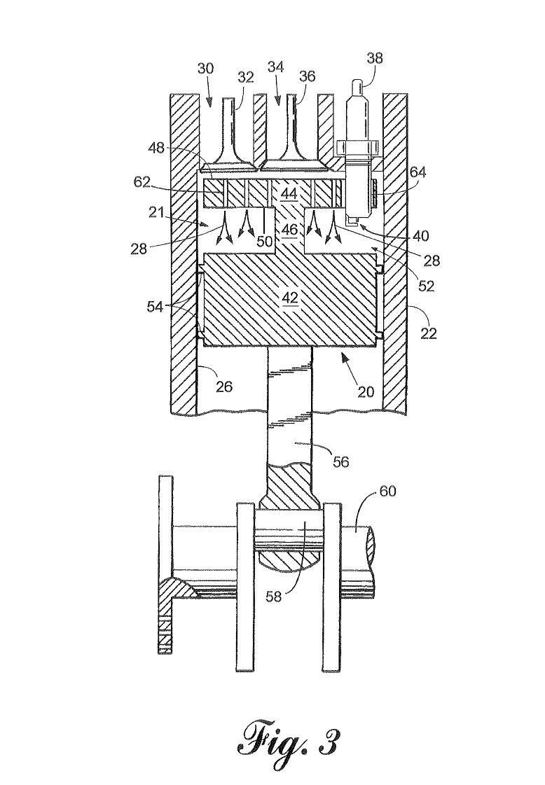

As shown in FIG. 2, the vaporizing ring 44 has a plurality of generally cylindrically-shaped passages 62 that provide fuel/air communication paths between the top surface 48 of the vaporizing ring 44 and the vapor chamber 52 (see FIGS. 1, 3). These passages 62 are evenly-distributed throughout the vaporizing ring 44. According to the preferred embodiment, the passages 62 are between one and two millimeters in diameter. The vaporizing ring 44 preferably has at least forty of the passages 62. None of the passages 62 are positioned over the stem 46 of the piston 20. Although the longitudinal axes of these passages 62 are parallel to the longitudinal axis of the bore 21 (see FIGS. 1, 3), alternative embodiments of the piston 20 may include passages 62 that are curved and/or non-parallel to increase the turbulent flow of the fuel/air mixture 28 passing through the vaporizing ring 44, which results in an increased degree of vaporization of the fuel/air mixture 28. The vaporizing ring 44 includes a spark plug passage 64 that provides access for the spark plug gap 40 to the vapor chamber 52 (see FIGS. 1, 3) when the piston 20 is in the top position.

FIG. 3 is a partial sectional view of the piston 20 and cylinder 22 following the compression stroke. Prior to the compression stroke, the input valve 32 is closed. As the piston 20 moves through a compression stroke, the fuel/air mixture 28 received into the compression chamber during the intake stroke is compressed and also forced through the plurality of passages 62 in the vaporizing ring 44. Much of the fuel/air mixture 28 moves through the vaporizing ring 44 and into the vapor chamber 52, although some of the mixture 28 may move between the ring 44 and sidewall 26 of the cylinder 22 into the chamber 52. As the fuel/air mixture 28 is pushed through the plurality of passages 62 and between the vaporizing ring 44 and sidewall 26, this turbulent movement increases the degree of vaporization of the fuel/air mixture 28. To initiate the combustion stroke, which forces the piston 20 to the “down” position and turns the shaft 60 to create power, a spark is caused at the spark gap 40, which ignites the fuel/air mixture 28, which in turn causes an explosion that exerts downward force against the piston body 42. Because of the greater degree of vaporization of the fuel/air mixture 28 in the vapor chamber 52 as a result of the movement of the mixture 28 through the passages 62 of the vaporizing ring 44, more fuel burns during the combustion.

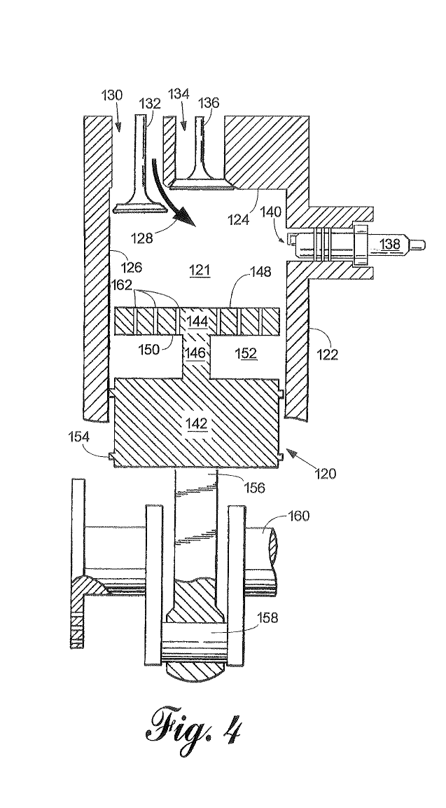

FIG. 4 discloses an alternative embodiment of the piston 120 of the present invention between an intake stroke and a compression stroke of an internal combustion engine. As described with reference to the preferred embodiment, a fuel/air mixture 128 is provided through an intake port 130, access to which is controlled by selectively opening and closing an intake valve 132. After combustion of the fuel/air mixture 128, the resulting exhaust is forced from the bore 121 of the cylinder 122 through an exhaust port 134, access to which is controlled by selectively opening and closing an exhaust valve 136. A spark plug 138 threaded through the sidewall 126 of the cylinder 122 provides an ignition source for the fuel/air mixture 128 using a spark gap 140. The piston body 142 includes sealing members 154 that seal the bore 121 against the entry or egress of gasses.

As described with reference to the preferred embodiment, the alternative embodiment of the piston 120 includes a piston body 142 connected with a stem 146 to a vaporizing ring 144 with a top surface 148 and a bottom surface 150. The bottom surface 150 of the vaporizing ring 144 and piston body 142 define a vapor chamber 152, which is further defined by the sidewall 126 of the cylinder 122. The vaporizing ring 144 and stem 146 may be made from any suitable high-temperature material, which include any materials used to make traditional pistons for use in combustion engines. The piston body 142 is attached to a shaft 160 with a connecting rod 156. The controlling rod 156 is attached to a cam 158 that rotates about the longitudinal axis of the shaft 160 as the piston 120 reciprocates between the “top” and “down” positions in the cylinder 122.

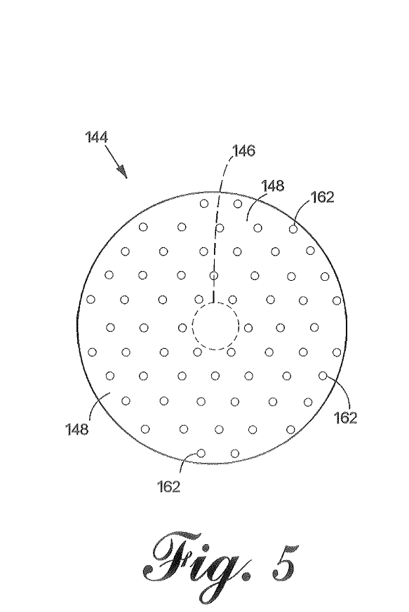

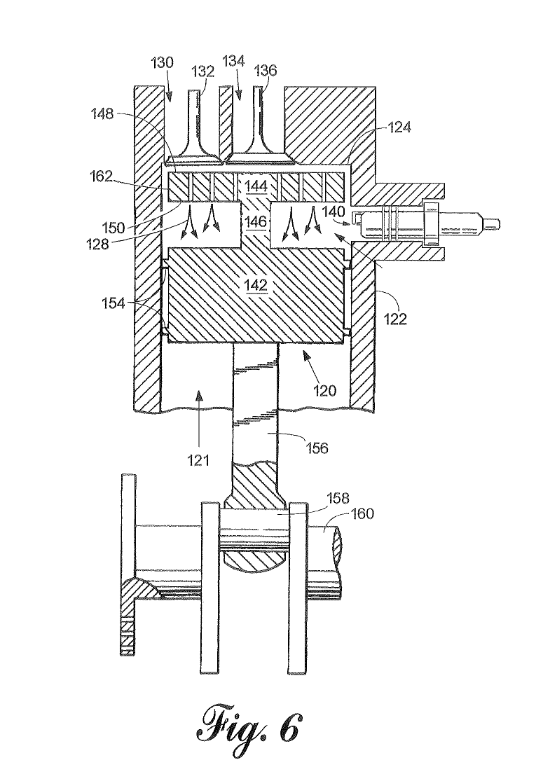

As shown in FIG. 5, the vaporizing ring 144 has a plurality of generally cylindrically-shaped passages 162 that provide fuel/air communication paths between the top surface 148 of the vaporizing ring 144 and the vapor chamber (FIGS. 4, 6). These passages 162 are evenly-distributed throughout the vaporizing ring 144. None of the passages 162 are positioned over the stem 146 of the piston 120. Although the longitudinal axes of these passages 162 are parallel to the longitudinal axis of the bore 121 (see FIGS. 4, 6), alternative embodiments of the piston 120 may include passages 162 that are curved and/or non-parallel to increase the turbulent flow of the fuel/air mixture 128 passing through the vaporizing ring 144, which results in an increased degree of vaporization.

FIG. 6 is a partial sectional view of the alternative embodiment of the present invention following a compression stroke. Prior to a compression stroke, the input valve 132 is closed. As the piston 120 moves through a compression stroke, the fuel/air mixture 128 received into the bore 121 during the intake stroke is compressed and also forced through the plurality of passages 162 in the vaporizing ring 144. To initiate the combustion stroke, which forces the piston 120 to the “down” position and turns the shaft 160 to create power, a spark is caused at the spark gap 140 adjacent to the vapor chamber 152, which ignites the fuel/air mixture 128 causing an explosion that exerts downward force against the piston body 142. Because of the greater degree of vaporization of the fuel/air mixture 128 in the vapor chamber 152 as a result of the movement of the mixture 128 through the passages 162, more fuel burns during combustion.

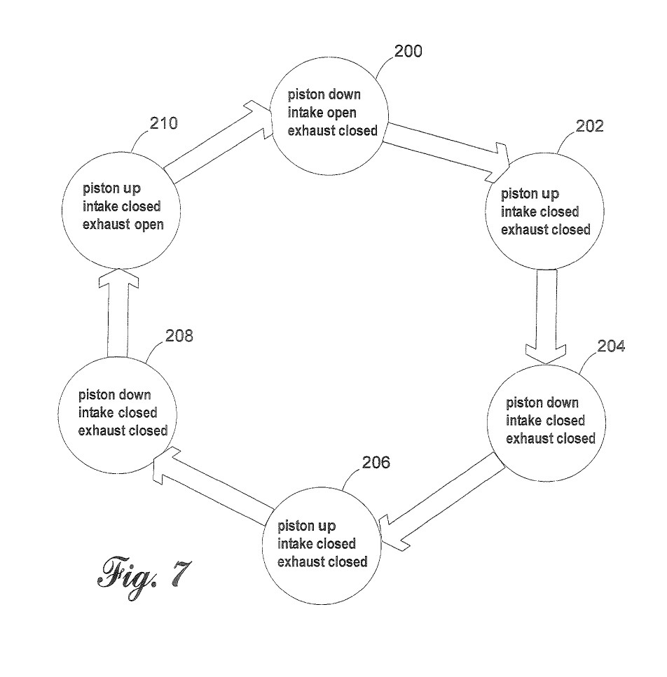

As described with reference to FIG. 7, the piston design may be used in combination with a six-stroke cycle engine to further increase the degree of vaporization of the fuel/air mixture. A typical, four-stroke cycle engine has an intake stroke 200, a first compression stroke 202, a combustion stroke 208, and an exhaust stroke 210. During the intake stroke 200, the intake valve is open (as previously described) so that the fuel/air mixture may be drawn into the cylinder through the intake port. Thereafter, the intake valve closes, and the fuel/air mixture is compressed prior to combustion so that ignition of the mixture at the start of the combustion stroke 202 will cause a greater explosion and faster rate of expansion of the combusting mixture (relative to an uncompressed mixture) to force the piston to the “down” position and cause the attached shaft to rotate, thus generating usable power. Thereafter, the exhaust valve is opened to provide a communication path to the exhaust port for exhaust remaining from the combustion. The piston is forced to the “up” position by rotation of the shaft and the exhaust evacuated from the cylinder bore.

By incorporating a vapor stroke 204 and a second compression stroke 206 between the first compression stroke 202 and combustion stroke 208, the fuel/air mixture is forced through the vaporizing ring two additional times: once during the vapor stroke 204 when the piston is moving to the “down” position, and once more when the piston is moving back up during the second compression stroke 206. This further increases the degree of vaporization of the fuel/air mixture, resulting in a more efficient burn and less unused fuel. During the second compression stroke 206 and vapor stroke 204, both the intake valve and exhaust valve remain closed.

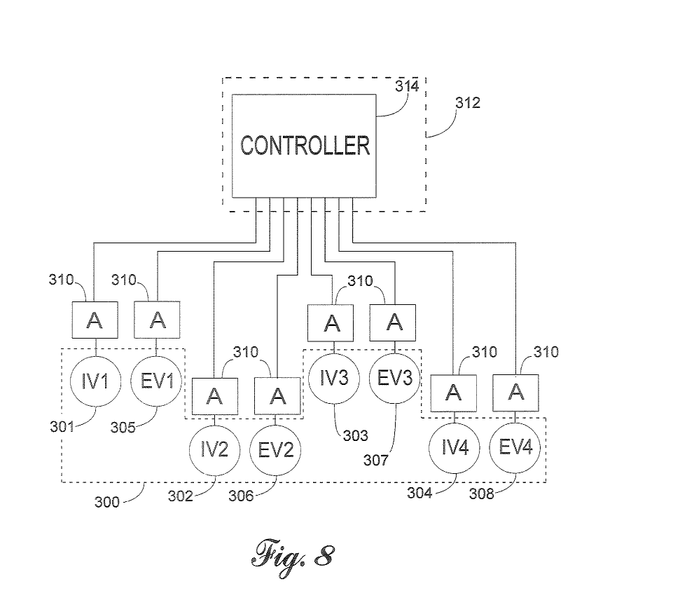

As shown in FIG. 8, the efficiency of an engine incorporating use of the piston of the present invention may be further increased through the use of electrically or hydraulically actuated intake and exhaust valves. The configuration shown in FIG. 8 represents a four-cylinder combustion engine, although the same principle may be applied to a combustion engine having any number of cylinders.

Each of the intake valves 301-304 and exhaust valves 305-308 within the engine block 300 is connected to an actuator 310. Each of the actuators 310 is electrically controlled by connected actuating means 312. According to this embodiment, the actuating means comprises a controller 314, which may be a microprocessor or microcontroller. The controller 314 is electrically connected to each of the actuators 310 and may cause the actuators 310 to open or close the attached intake valves 301-304 and exhaust valves 305-308. In this manner, the timing of the opening and closing of the intake valves 301-304 and exhaust valves 305-308 may be optimized, and less energy required to open the valves compared to the use of mechanical means such as cams and cam followers.

The present invention is described above in terms of a preferred illustrative embodiment of a specifically described piston and combustion engine, as well as alternative embodiments thereof. Those skilled in the art will recognize that alternative constructions can be used in carrying out the present invention. Other aspects, features, and advantages of the present invention may be obtained from a study of this disclosure and the drawings, along with the appended claims.

I claim:

1. A piston for use in a bore of a cylinder of an internal combustion engine, the piston comprising:
a piston body adapted for reciprocating movement within said bore;
a vaporizing ring having a top and a bottom surface, said vaporizing ring connected to said piston body to define an vapor chamber therebetween; and
wherein said vaporizing ring has a plurality of evenly-distributed passages providing fuel/air communication paths between said top surface and said vapor chamber.

2. The piston of claim 1 wherein the diameter of each of said passages is smaller than three millimeters.

3. The piston of claim 1 wherein the diameter of each of said passages is between one millimeter and two millimeters.

4. The piston of claim 1 wherein said plurality of passages is at least forty passages.

5. The piston of claim 1 further comprising a spark plug passage adapted to provide access to said vapor chamber by a spark plug gap prior to a combustion cycle.

6. A combustion engine comprising:
at least one cylinder having a bore in selective communication with an intake port and an exhaust port, said selective communication with said intake port determined by the state of an intake valve and said selective communication with said exhaust port determined by the state of an exhaust valve;
at least one piston for use in said at least one cylinder, said piston comprising:
a piston body adapted for reciprocating movement within said bore;
a vaporizing ring having a top and a bottom surface, said vaporizing ring connected to said piston body to define a vapor chamber therebetween; and
wherein said vaporizing ring has a plurality of evenly-distributed passages providing fuel/air communication paths between said top surface and said vapor chamber;
an actuator connected to each of said intake and exhaust valves and adapted to selectively open and close said valves, each actuator being either hydraulically or electrically triggered; and
actuating means operably connected to each of said actuators for selective actuation thereof.

7. The engine of claim 6 wherein the diameter of each of said passages is smaller than three millimeters.

8. The engine of claim 6 wherein the diameter of each of said passages is between one millimeter and two millimeters.

9. The engine of claim 6 wherein said plurality of passages is at least forty passages.

10. The piston of claim 6 further comprising a spark plug passage adapted to provide access to said vapor chamber by a spark plug gap prior to a combustion cycle.

11. This engine of claim 6 wherein said actuating means is a controller.

12. The engine of claim 6 wherein each cycle of said at least one piston includes an intake stroke, a first compression stroke, a vapor stroke, a second compression stroke, a combustion stroke, and an exhaust stroke.

13. A combustion engine comprising:
at least one cylinder having a bore in selective communication with an intake port and an exhaust port, said selective communication with said intake port determined by the state of an intake valve and said selective communication with said exhaust port determined by the state of an exhaust valve;
at least one piston for use in said at least one cylinder, said piston comprising:
a piston body adapted for reciprocating movement within said bore;
a vaporizing ring having a top and a bottom surface, said vaporizing ring connected to said piston body to define a vapor chamber therebetween; and
wherein said vaporizing ring has a plurality of evenly-distributed passages providing fuel/air communication paths between said top surface and said vapor chamber; and
wherein each cycle of said at least one piston includes an intake stroke, a first compression stroke, a vapor stroke, a second compression stroke, a combustion stroke, and an exhaust stroke.
